(19) United States
(12) Patent Application Publication
(10) Pub. No.: US 2023/0092949 A1
(43) Pub. Date: Mar. 23, 2023

(54) SYSTEM AND METHOD FOR ESTIMATING MODEL METRICS WITHOUT LABELS

(71) Applicants: Divya Gopinath, Millwood, NY (US); David Sandai Kurokawa, Kirkland, WA (US); Shayak Sen, San Mateo, CA (US); Anupam Datta, Redwood City, CA (US)

(72) Inventors: Divya Gopinath, Millwood, NY (US); David Sandai Kurokawa, Kirkland, WA (US); Shayak Sen, San Mateo, CA (US); Anupam Datta, Redwood City, CA (US)

(21) Appl. No.: 17/897,621

(22) Filed: Aug. 29, 2022

Related U.S. Application Data
(60) Provisional application No. 63/246,225, filed on Sep. 20, 2021.

(51) Int. Cl. G06N 3/04; G06N 3/08

(52) U.S. Cl. CPC G06N 3/0472; G06N 3/08

(57) ABSTRACT

A computer accesses an artificial intelligence (AI) model, a labeled in-sample (IS) dataset, and an unlabeled out-of-sample (OOS) dataset, the labeled IS dataset storing IS input values and corresponding IS output values, the unlabeled OOS dataset storing OOS input values but not corresponding OOS output values. The computer modifies, via importance sampling and based on a likelihood that a given datapoint from the IS dataset is associated with the OOS dataset, weights of multiple datapoints in the labeled IS dataset to generate a weighted IS dataset. The computer calculates an estimated performance metric of the AI model on the OOS dataset using at least a subset of datapoints in the weighted IS dataset. The computer provides an output representing the estimated performance metric of the AI model on the OOS dataset.

This application claims the benefit of priority under 35 U.S.C. 119(e) to U.S. Provisional Patent Application Ser. No. 63/246,225, filed Sep. 20, 2021, which is incorporated herein by reference in its entirety.

### TECHNICAL FIELD

Embodiments pertain to computer architecture. Some embodiments relate to machine learning. Some embodiments relate to estimating model metrics without labels.

### BACKGROUND

An artificial intelligence or statistical model may be used in conjunction with a first, labeled dataset. Techniques for predicting the model's performance on a second, unlabeled dataset, which may be statistically different from the first dataset, may be desirable.

### BRIEF DESCRIPTION OF THE DRAWINGS

FIG. 1 illustrates the training and use of a machine-learning program, in accordance with some embodiments.

FIG. 2 illustrates an example neural network, in accordance with some embodiments.

FIG. 3 illustrates the training of an image recognition machine learning program, in accordance with some embodiments.

FIG. 4 illustrates the feature-extraction process and classifier training, in accordance with some embodiments.

FIG. 5 is a block diagram of a computing machine, in accordance with some embodiments.

FIG. 6 is a flow chart of a process for estimating model metrics without labels, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Aspects of the present technology may be implemented as part of a computer system. The computer system may be one physical machine, or may be distributed among multiple physical machines, such as by role or function, or by process thread in the case of a cloud computing distributed model. In various embodiments, aspects of the technology may be configured to run in virtual machines that in turn are executed on one or more physical machines. It will be understood by persons of skill in the art that features of the technology may be realized by a variety of different suitable machine implementations.

The system includes various engines, each of which is constructed, programmed, configured, or otherwise adapted, to carry out a function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines comprise a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, each of which may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

As used herein, the term “model” encompasses its plain and ordinary meaning. A model may include, among other things, one or more engines which receive an input and compute an output based on the input. The output may be a classification. For example, an image file may be classified as depicting a cat or not depicting a cat. Alternatively, the image file may be assigned a numeric score indicating a likelihood whether the image file depicts the cat, and image files with a score exceeding a threshold (e.g., 0.9 or 0.95) may be determined to depict the cat.

This document may reference a specific number of things (e.g., “six mobile devices”). Unless explicitly set forth otherwise, the numbers provided are examples only and may be replaced with any positive integer, integer or real number, as would make sense for a given situation. For example, “six mobile devices” may, in alternative embodiments, include any positive integer number of mobile devices. Unless otherwise mentioned, an object referred to in singular form (e.g., “a computer” or “the computer”) may include one or multiple objects (e.g., “the computer” may refer to one or multiple computers).

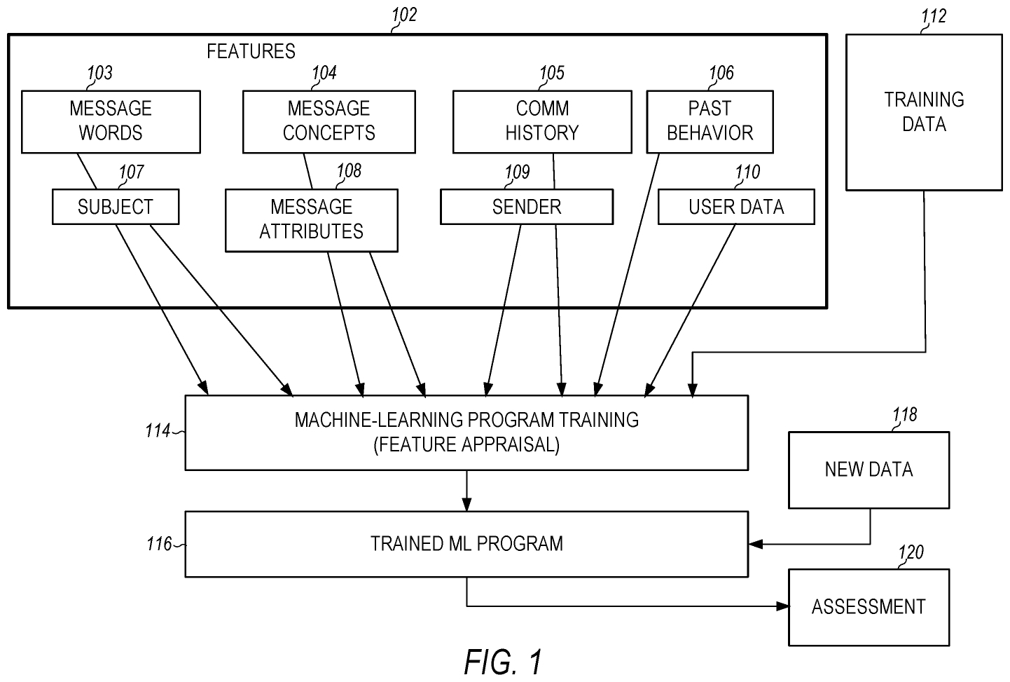

FIG. 1 illustrates the training and use of a machine-learning program, according to some example embodiments. In some example embodiments, machine-learning programs (MLPs), also referred to as machine-learning algorithms or tools, are utilized to perform operations associated with machine learning tasks, such as image recognition or machine translation.

Machine learning is a field of study that gives computers the ability to learn without being explicitly programmed. Machine learning explores the study and construction of algorithms, also referred to herein as tools, which may learn from existing data and make predictions about new data. Such machine-learning tools operate by building a model from example training data 112 in order to make data-driven predictions or decisions expressed as outputs or assessments 120. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange). Regression algorithms aim at quantifying some items (for example, by providing a value that is a real number). The machine-learning algorithms utilize the training data 112 to find correlations among identified features 102 that affect the outcome.

The machine-learning algorithms utilize features 102 for analyzing the data to generate assessments 120. A feature 102 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

In one example embodiment, the features 102 may be of different types and may include one or more of words of the message 103, message concepts 104, communication history 105, past user behavior 106, subject of the message 107, other message attributes 108, sender 109, and user data 110.

The machine-learning algorithms utilize the training data 112 to find correlations among the identified features 102 that affect the outcome or assessment 120. In some example embodiments, the training data 112 includes labeled data, which is known data for one or more identified features 102 and one or more outcomes, such as detecting communication patterns, detecting the meaning of the message, generating a summary of the message, detecting action items in the message, detecting urgency in the message, detecting a relationship of the user to the sender, calculating score attributes, calculating message scores, etc.

With the training data 112 and the identified features 102, the machine-learning tool is trained at operation 114. The machine-learning tool appraises the value of the features 102 as they correlate to the training data 112. The result of the training is the trained machine-learning program 116.

When the machine-learning program 116 is used to perform an assessment, new data 118 is provided as an input to the trained machine-learning program 116, and the machine-learning program 116 generates the assessment 120 as output. For example, when a message is checked for an action item, the machine-learning program utilizes the message content and message metadata to determine if there is a request for an action in the message.

Machine learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

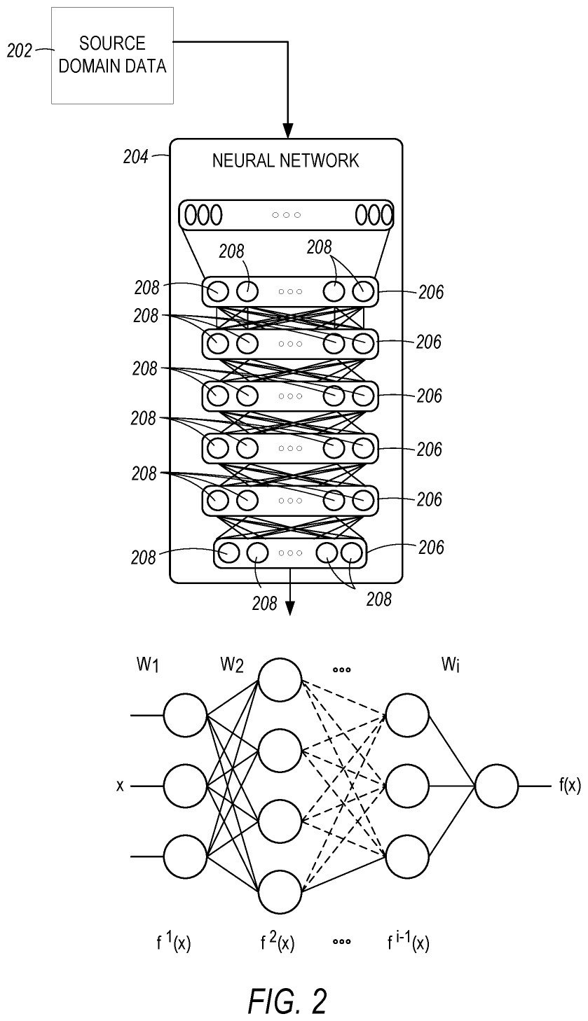

FIG. 2 illustrates an example neural network 204, in accordance with some embodiments. As shown, the neural network 204 receives, as input, source domain data 202. The input is passed through a plurality of layers 206 to arrive at an output. Each layer 206 includes multiple neurons 208. The neurons 208 receive input from neurons of a previous layer and apply weights to the values received from those neurons in order to generate a neuron output. The neuron outputs from the final layer 206 are combined to generate the output of the neural network 204.

As illustrated at the bottom of FIG. 2, the input is a vector x. The input is passed through multiple layers 206, where weights W₁, W₂, . . . , Wᵢ are applied to the input to each layer to arrive at f¹(x), f²(x), . . , fⁱ⁻¹(x), until finally the output f(x) is computed.

In some example embodiments, the neural network 204 (e.g., deep learning, deep convolutional, or recurrent neural network) comprises a series of neurons 208, such as Long Short Term Memory (LSTM) nodes, arranged into a network. A neuron 208 is an architectural element used in data processing and artificial intelligence, particularly machine learning, which includes memory that may determine when to “remember” and when to “forget” values held in that memory based on the weights of inputs provided to the given neuron 208. Each of the neurons 208 used herein are configured to accept a predefined number of inputs from other neurons 208 in the neural network 204 to provide relational and sub-relational outputs for the content of the frames being analyzed. Individual neurons 208 may be chained together and/or organized into tree structures in various configurations of neural networks to provide interactions and relationship learning modeling for how each of the frames in an utterance are related to one another.

For example, an LSTM node serving as a neuron includes several gates to handle input vectors (e.g., phonemes from an utterance), a memory cell, and an output vector (e.g., contextual representation). The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., recognize units of speech). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

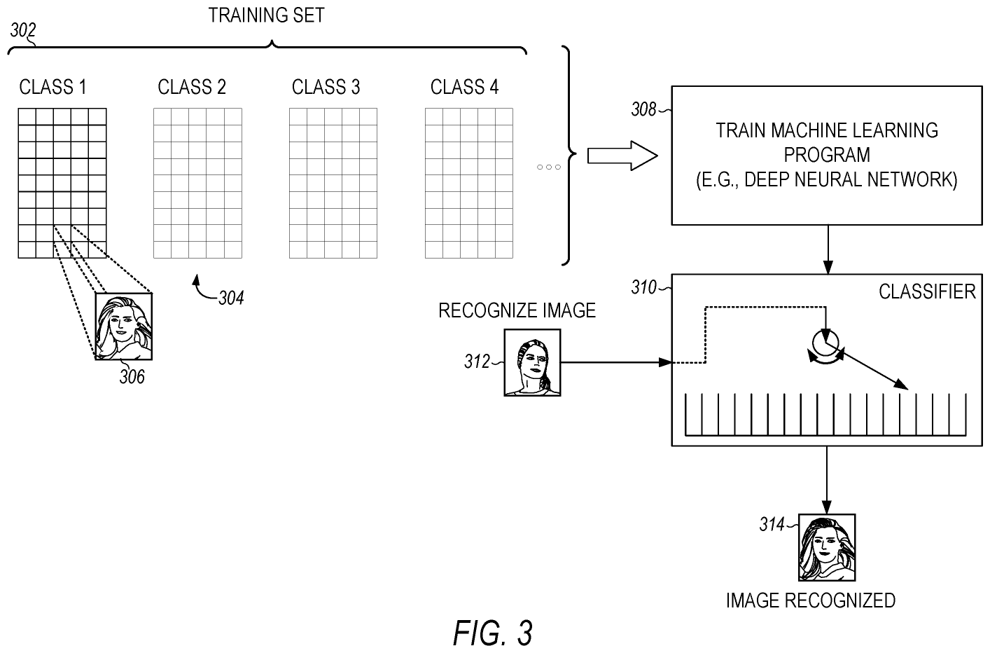

FIG. 3 illustrates the training of an image recognition machine learning program, in accordance with some embodiments. The machine learning program may be implemented at one or more computing machines. A training set 302 includes multiple classes 304. Each class 304 includes multiple images 306 associated with the class. Each class 304 may correspond to a type of object in the image 306 (e.g., a digit 0-9, a man or a woman, a cat or a dog, etc.). In one example, the machine learning program is trained to recognize images of the presidents of the United States, and each class corresponds to each president (e.g., one class corresponds to Barack Obama, one class corresponds to George W. Bush, one class corresponds to Bill Clinton, etc.). At block 308 the machine learning program is trained, for example, using a deep neural network. A trained classifier 310, generated by the training of block 308, recognizes an image 312, and at block as image 314. For example, if the image 312 is a photograph of Bill Clinton, the classifier recognizes the image as corresponding to Bill Clinton.

FIG. 3 illustrates the training of a classifier, according to some example embodiments. A machine learning algorithm is designed for recognizing faces, and a training set 302 includes data that maps a sample to a class 304 (e.g., a class includes all the images of purses). The classes may also be referred to as labels. Although embodiments presented herein are presented with reference to object recognition, the same principles may be applied to train machine-learning programs used for recognizing any type of items.

The training set 302 includes a plurality of images 306 for each class 304 (e.g., image 306), and each image is associated with one of the categories to be recognized (e.g., a class). The machine learning program is trained 308 with the training data to generate a classifier 310 operable to recognize images. In some example embodiments, the machine learning program is a DNN.

When an input image 312 is to be recognized, the classifier 310 analyzes the input image 312 to identify the class (e.g., class of image 314) corresponding to the input image 312.

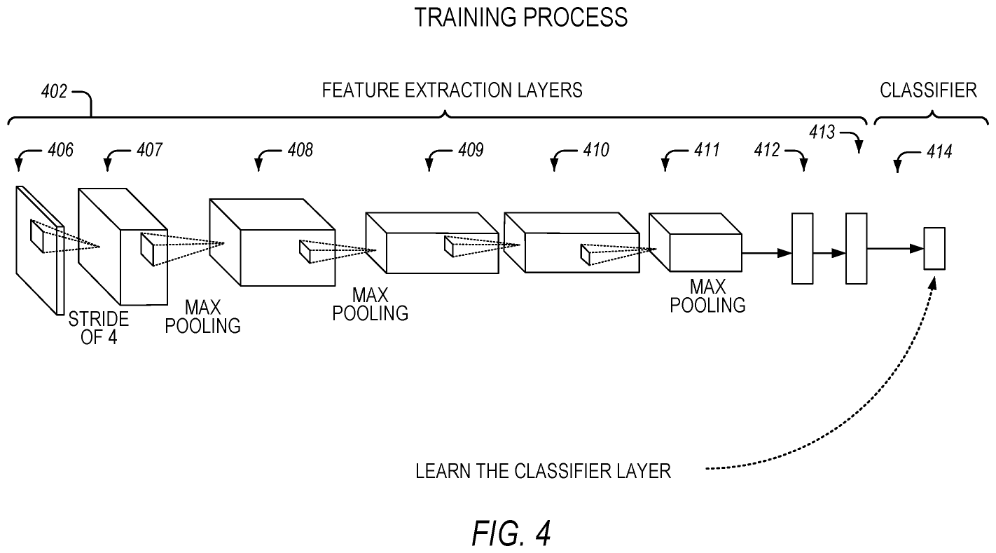

FIG. 4 illustrates the feature-extraction process and classifier training, according to some example embodiments. Training the classifier may be divided into feature extraction layers 402 and classifier layer 414. Each image is analyzed in sequence by a plurality of layers 406-413 in the feature-extraction layers 402.

With the development of deep convolutional neural networks, the focus in face recognition has been to learn a good face feature space, in which faces of the same person are close to each other, and faces of different persons are far away from each other. For example, the verification task with the LFW (Labeled Faces in the Wild) dataset has been often used for face verification.

Many face identification tasks (e.g., MegaFace and LFW) are based on a similarity comparison between the images in the gallery set and the query set, which is essentially a K-nearest-neighborhood (KNN) method to estimate the person's identity. In the ideal case, there is a good face feature extractor (inter-class distance is always larger than the intra-class distance), and the KNN method is adequate to estimate the person's identity.

Feature extraction is a process to reduce the amount of resources required to describe a large set of data. When performing analysis of complex data, one of the major problems stems from the number of variables involved. Analysis with a large number of variables generally requires a large amount of memory and computational power, and it may cause a classification algorithm to overfit to training samples and generalize poorly to new samples. Feature extraction is a general term describing methods of constructing combinations of variables to get around these large data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with very sparse data) to smaller vectors capturing the same, or similar, amount of information.

Determining a subset of the initial features is called feature selection. The selected features are expected to contain the relevant information from the input data, so that the desired task can be performed by using this reduced representation instead of the complete initial data. DNN utilizes a stack of layers, where each layer performs a function. For example, the layer could be a convolution, a non-linear transform, the calculation of an average, etc. Eventually this DNN produces outputs by classifier layer 414. In FIG. 4, the data travels from left to right and the features are extracted. The goal of training the neural network is to find the parameters of all the layers that make them adequate for the desired task.

As shown in FIG. 4, a “stride of 4” filter is applied at layer 406, and max pooling is applied at layers 407-413. The stride controls how the filter convolves around the input volume. “Stride of 4” refers to the filter convolving around the input volume four units at a time. Max pooling refers to down-sampling by selecting the maximum value in each max pooled region.

In some example embodiments, the structure of each layer is predefined. For example, a convolution layer may contain small convolution kernels and their respective convolution parameters, and a summation layer may calculate the sum, or the weighted sum, of two pixels of the input image. Training assists in defining the weight coefficients for the summation.

One way to improve the performance of DNNs is to identify newer structures for the feature-extraction layers, and another way is by improving the way the parameters are identified at the different layers for accomplishing a desired task. The challenge is that for a typical neural network, there may be millions of parameters to be optimized. Trying to optimize all these parameters from scratch may take hours, days, or even weeks, depending on the amount of computing resources available and the amount of data in the training set.

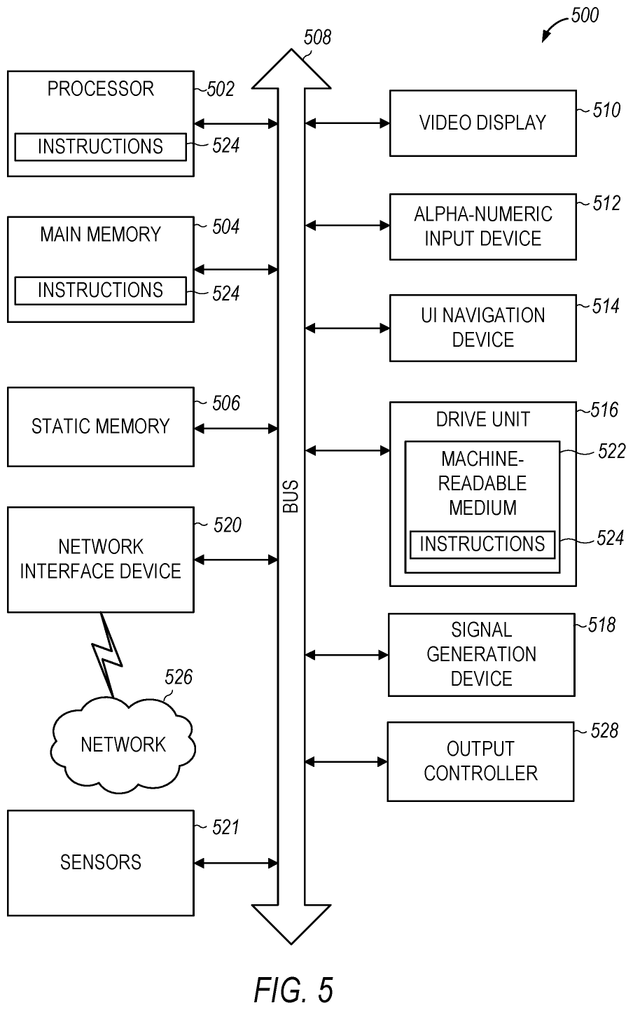

FIG. 5 illustrates a circuit block diagram of a computing machine 500 in accordance with some embodiments. In some embodiments, components of the computing machine 500 may store or be integrated into other components shown in the circuit block diagram of FIG. 5. For example, portions of the computing machine 500 may reside in the processor 502 and may be referred to as “processing circuitry.” Processing circuitry may include processing hardware, for example, one or more central processing units (CPUs), one or more graphics processing units (GPUs), and the like. In alternative embodiments, the computing machine 500 may operate as a standalone device or may be connected (e.g., networked) to other computers. In a networked deployment, the computing machine 500 may operate in the capacity of a server, a client, or both in server-client network environments. In an example, the computing machine 500 may act as a peer machine in peer-to-peer (P2P) (or other distributed) network environment. In this document, the phrases P2P, device-to-device (D2D) and sidelink may be used interchangeably. The computing machine 500 may be a specialized computer, a personal computer (PC), a tablet PC, a personal digital assistant (PDA), a mobile telephone, a smart phone, a web appliance, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems/apparatus (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The computing machine 500 may include a hardware processor 502 (e.g., a central processing unit (CPU), a GPU, a hardware processor core, or any combination thereof), a main memory 504 and a static memory 506, some or all of which may communicate with each other via an interlink (e.g., bus) 508. Although not shown, the main memory 504 may contain any or all of removable storage and non-removable storage, volatile memory or non-volatile memory. The computing machine 500 may further include a video display unit 510 (or other display unit), an alphanumeric input device 512 (e.g., a keyboard), and a user interface (UI) navigation device 514 (e.g., a mouse). In an example, the display unit 510, input device 512 and UI navigation device 514 may be a touch screen display. The computing machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The computing machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The drive unit 516 (e.g., a storage device) may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the computing machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the computing machine 500 and that cause the computing machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, interne protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526.

Some embodiments relate to a system and method for estimating the performance of a binary classification model on an unlabeled dataset. Given a classification model and a baseline dataset that is labeled, some embodiments estimate the performance of the model on a second dataset that is not labeled. Some embodiments are related to the general problem of drift. As used herein, “drift” may refer to differences between the training dataset and the inference dataset. For example, an ANN-based model for predicting loan default may have been trained primarily on male applicants, but may be used, in the inference phase, on both male and female applicants.

Although an artificial intelligence (e.g., machine learning) model is trained on a slice of data that is meant to represent real-world conditions, this data can change over time or differ by segment. Thus, a model's performance in-the-wild can drift over time. Generally, this drift occurs in one of three ways (some examples below use a simple model that predicts whether an individual should be granted a loan as a demonstrative example of each category).

For data drift, consider a model f which is trained on in-sample (IS) data and labels X_{IS}, K_{IS} and is now being evaluated on out-of-sample (OOS) data X_{OOS}, Y_{OOS}. If only data drift occurs, then X_{IS} differs from X_{OOS}, but the relationship between inputs and outputs P(y|x) remains unchanged, where P or p represent probability. As an example, a loan model trained on mostly male applicants suddenly sees many female applicants apply for loans, which is different from the scenario on which it was trained.

In the case of concept drift, while X_{IS}≈X_{OOS} and the input data is similar, the relationship P(y|x) has changed. This is an indication that the model is capturing an out-of-date relationship between inputs and outputs. As an example, unemployment skyrockets due to an unforeseen circumstance, causing the chance of an individual defaulting on their loan to dramatically increase.

In the real world, drift may be constantly occurring, and is likely a mix of both data and concept drift.

Drift can cause degradation of model performance, which may be useful to detect. If a computing machine (e.g., computing machine 100) has access to the out-of-sample labeled data X_{OOS} and Y_{OOS}, then this degradation may be easily detected by measuring model performance on this OOS data. However, in the real-world, these labels may not be immediately available. For example, in monetary lending, it might not be possible to observe whether an individual defaults on his/her loan for 6-12 months. Thus, it is useful to give an estimate of model performance on the OOS data X_{OOS} without access to the ground-truth labels Y_{OOS}. As used herein, “ground-truth” may refer to information that is known to be real or true, provided by direct observation and measurement as opposed to information provided by inference.

Without access to labels, it may be impossible to know whether p(y|x)changes. Thus, some embodiments make these estimations with the explicit assumption that there is no (or less than a predefined threshold amount of) concept drift between in-sample and out-of-sample data. In other words, some embodiments assume that p(y|x)remains unchanged across data splits.

Some embodiments are based on the steps below, addressing the problem of estimating model performance on new, OOS data without access to ground-truth labels.

The input may include: a model, labeled IS data on which the model was trained (or used in inference after training), and labeled OOS data. In some embodiments, a computing machine reweights the labeled IS data to resemble the OOS data. The reweighting is achieved via importance sampling. The computing machine recalculates the performance of the model on OOS data using weighted, labeled samples from IS data. This technique may be applicable to any classification performance metric that can be weighted by each sample, including but not limited to precision, recall, classification accuracy, F1-score, and receiver operating characteristic area under the curve (ROC-AUC).

The F1-score is the harmonic mean of precision and recall. The F1-score may be calculated according to Equation (1) below, where tp is the proportion of true positives, fp is the proportion of false positives, and fn is the proportion of false negatives. Precision is defined in Equation (2). Recall is defined in Equation (3).

F1=2/(recall⁻¹+precision⁻¹)=tp/(tp+0.5(fp+fn)) (1)

precision=tp/(tp+fp) (2)

recall=tp/(tp+fn) (3)

The receiver operating characteristic (ROC) curve for an artificial intelligence or statistical model is created by plotting the true positive rate against the false positive rate at various threshold settings for the model. The ROC-AUC measures the area under the ROC curve.

Some embodiments relate to a binary classifier f trained on labeled in-sample data X_{IS}, Y_{IS} and calibrated to this data set (if not calibrated originally, it can be calibrated by sampling from X_{IS}, Y_{IS}). The data gives us access to p_{IS}(x, y), as well as p_{IS}(x). In some cases, f approximately models p_{IS}(y|x). The computing machine has access to unlabeled out-of-sample X_{OOS} but not Y_{OOS}. Some embodiments assume that p_{OOS}(y|x)=p_{IS}(y|x), or that there is no (or less than a predefined threshold amount of) concept drift between splits.

The objective of some embodiments is to approximate the performance of f on X_{OOS}. The calculated performance metrics may include precision, recall, ROC-AUC, and classification accuracy. These metrics may be defined as expectations of functions Φ with respect to p_{OOS}(x|y), to which the computing machine may lack access. However, using importance sampling, the computing machine may use p_{OOS}(x) for this purpose.

For any function Φ, the definition of its expected value is shown in Equation (4). The term p^{OOS}(x|y) may be rewritten using Bayes' theorem, as shown in Equation (5). Because 1/p^{OOS}(y) does not depend on x, it may be removed from the expectation, shown in Equation (6). Some embodiments assume without loss of generality that y=1, in these embodiments, the average/expected value of the calibrated classifier f_{cal} may be equal to p^{OOS}(y), resulting in Equation (7).

$${E}_{x \sim {p}^{OOS} ( x \vert y )} [ Φ ( x ) ] = {\sum }_{x} Φ ( x ) {p}^{OOS} ( x \vert y ) \qquad ( 4 )$$

$${E}_{x \sim {p}^{OOS} ( x \vert y )} [ Φ ( x ) ] = {\sum }_{x} Φ ( x ) {p}^{OOS} ( x ) \frac{{p}^{OOS} ( x \vert y )}{{p}^{OOS} ( x )} = {\sum }_{x} Φ ( x ) {p}^{OOS} ( x ) \frac{{p}^{OOS} ( y \vert y )}{{p}^{OOS} ( y )} \qquad ( 5 )$$

$${E}_{x \sim {p}^{OOS} ( x \vert y )} [ Φ ( x ) ] = \frac{1}{{p}^{OOS} ( y )} {\sum }_{x} Φ ( x ) {p}^{OOS} ( x ) {p}^{OOS} ( y \vert x ) \qquad ( 6 )$$

$${E}_{x \sim {p}^{OOS} ( x \vert y )} [ Φ ( x ) ] = {E}_{x \sim {p}^{OOS} ( x )} [ Φ ( x ) {f}_{cal} ] / {E}_{x \sim {p}^{OOS} ( x )} [ {f}_{cal} ( x ) ] \qquad ( 7 )$$

In some embodiments, the computing machine might find f_{cal} by calibrating f against x, y drawn from p_{OOS}(x, y), but we lack the labels to do this. However, for any arbitrary function Ψ, using the definition of expected value results in Equation (7). Expanding p(x,y)=p(y|x)p(x) using the laws of probability results in Equation (8). Noting that p(y|x) is equivalent between IS and OOS data under some assumptions results in an example goal as shown in Equation (9). In an example usage for estimating OOS accuracy of Equation (9): Ψ(x,y)=if (f(x)=y) then 1.0 else 0.0. That is, with importance sampling, some embodiments may sample from the joint in-sample distribution, with an extra reweighting factor p_{OOS}(x)/p_{IS}(x).

$${E}_{x , y \sim {p}^{OOS} ( x , y )} [ Ψ ( x , y ) ] = {\sum }_{x} Ψ ( x , y ) {p}^{OOS} ( x , y ) = {\sum }_{x} Ψ ( x , y ) {p}^{OOS} ( x , y ) \frac{{p}^{IS} ( x , y )}{{p}^{IS} ( x , y )} = {E}_{x , y \sim {p}^{IS} ( x , y )} [ Ψ ( x , y ) \frac{{p}^{OOS} ( x , y )}{{p}^{IS} ( x , y )} ] \qquad ( 7 )$$

$${E}_{x , y \sim {p}^{OOS} ( x , y )} [ Ψ ( x , y ) ] = {E}_{x , y \sim {p}^{IS} ( x , y )} [ Ψ ( x , y ) \frac{{p}^{OOS} ( y \vert x ) {p}^{OOS} ( x )}{{p}^{IS} ( y \vert x ) {p}^{IS} ( x )} ] \qquad ( 8 )$$

$${E}_{x , y \sim {p}^{OOS} ( x , y )} [ Ψ ( x , y ) ] = {E}_{x , y \sim {p}^{IS} ( x , y )} [ Ψ ( x , y ) \frac{{p}^{OOS} ( x )}{{p}^{IS} ( x )} ] \qquad ( 9 )$$

In order to use importance sampling to then estimate model performance metrics for unlabeled data, the computing machine may calculate p_{OOS}(x)/p_{IS}(x). There are two ways of doing this: density estimation and discriminator technique.

In density estimation, the computing machine solves for the numerator and denominator separately using kernel density estimation, and then divides the two quantities. The computing machine may use an out-of-the-box implementation of kernel density estimation, which are described in greater detail below.

Density estimation may, in some cases, be expensive and fickle depending on the data at hand. The discriminator technique is a technique that learns p_{OOS}(x)/p_{IS}(x) directly via a discriminator. This discriminator model f_{disc} is trained to differentiate between data points from the IS and OOS distributions X_{IS} and X_{OOS}. In some embodiments, the computing machine predicts the probability an instance x belongs to the IS data distribution versus the OOS data distribution. This training data is generated from available IS and OOS samples—the computing machine takes a random sample of IS and OOS data and assigns all IS points a label of 0 and OOS points a label of 1. Using the notation that p(IS)=p(x∈X_{IS}), or the prior that a datapoint belongs to the IS distribution, this discriminator then learns the function shown in Equation (10). Rearranging the terms of Equation (10) results in Equation (11). Based on Equation (11), a simple transformation to the output of the discriminator gives p_{OOS}(x)/p_{IS}(x) for a datapoint x.

$${f}_{disc} ( x ) = p ( IS \vert x ) = \frac{p ( x \vert IS ) p ( IS )}{p ( x )} = \frac{p ( x \vert IS ) p ( IS )}{p ( IS ) p ( x \vert IS ) + p ( OOS ) p ( x \vert OOS )} \qquad ( 10 )$$

$${p}_{OOS} ( x ) / {p}_{IS} ( x ) = \frac{1}{{f}_{disc} ( x )} - 1 \qquad ( 11 )$$

A process may include the following steps. First, one goal is to estimate model performance metrics like AUC, classification accuracy, and the like, on unlabeled data. To do this, the computing machine may sample from the out-of-sample conditional distribution p_{OOS}(x|y). However, the label y is unknown. Second, however, using importance sampling, the computing machine may mimic samples from p_{OOS}(x|y) by instead sampling from p_{OOS}(x), if given access to a calibrated model f_{cal} that is calibrated on the OOS joint distribution p_{OOS}(x, y). Third, again using importance sampling, the computing machine may mimic samples from the joint in-sample distribution, using an extra reweighting factor p_{OOS}(x)/p_{IS}(x). Fourth, to accomplish this, the computing machine trains a discriminator model to pick between IS and OOS data. The discriminator output can be used to approximate p_{OOS}(x)/p_{IS}(x) for a datapoint x without relying on more complex methods like kernel density estimation.

Kernel density estimation (KDE) is a non-parametric method for estimating the probability density function of a given random variable. It may also be referred to by its traditional name, the Parzen-Rosenblatt Window method. Given a sample of independent, identically distributed observations (x₁, x₂, . . . , xₙ) of a random variable from an unknown source distribution, the kernel density estimate, is given by Equation (12).

$$p ( x ) = \frac{1}{nh} {\sum }_{j = 1}^{n} K ( \frac{x - {x}_{j}}{h} ) \qquad ( 12 )$$

In Equation (12), K(a) is the kernel function and h is the smoothing parameter, also called the bandwidth.

Following the above process yields a method to estimate model metrics which may be called the recalibration method, as it involves recalibrating the original model f . However, it should be noted that a simpler variant is the reweight method, which follows only a subset of the above steps: in some embodiments the computing machine uses the fourth step to calculate weights p_{OOS}(x)/p_{IS}(x) for each in-sample datapoint, and then calculates model metrics directly using p_{OOS}(x)/p_{IS}(x) as sample weights.

One difference between these two methods is that, in the reweight method, the computing machine uses a discriminator to generate p_{OOS}(x)/p_{IS}(x) and directly reweight in-sample data. However, the computing machine makes use of the out-of-sample data p_{OOS}(x) in the recalibration method, but at the cost of simulating sampling from p_{OOS}(x|y) using a recalibrated model.

The reweight technique may be implemented as follows. Some embodiments use a conditional probability augmented dataset as described below. Some embodiments may calculate sample weights p_{OOS}(x)/p_{IS}(x) for data points x that are in the OOS distribution. Some embodiments can do this in one of two ways.

A first way uses density estimation to estimate p_{OOS}(x) and p_{IS}(x) independently. Some embodiments use an out-of-the-box kernel density estimation from sci-kit learn. To fit the density estimator, some embodiments give two arrays of data instances x (one for OOS data and one for IS data). The density estimator for OOS and IS data may then be queried by feeding in a new data instance and returning p_{OOS}(x) and p_{IS}(x) directly.

In a second way, the computing machine trains a discriminator f_{disc} to estimate this ratio directly. The discriminator is trained on data instances x. However, feeding in raw x data into the model may make it difficult to train a suitably performant discriminator, because each feature within the raw data is not normalized and also contains a mix of numerical and categorical data. Some embodiments make use of two ways to transform x such that the f_{disc} is easy to train. Some implementations use the raw data instances x without any additional transforms. In other implementations, to mitigate the issues with having a poorly defined distance metric for the raw data due to categorical variables and lack of normalization, some embodiments use normalized influences using the Quantitative Input Influence (QII) framework. This could be extended to any normalization strategy e.g., z-scoring. Normalized QII values for both in-sample and out-of-sample are computed using a Python library, stored using the Conditional Probability Augmented Dataset and converted to pandas DataFrames (matrices) for downstream algebraic operations.

Some embodiments use a standard logistic regression model as f_{disc}, which is inherently calibrated. Some embodiments implement the discriminator in Python using scikit-learn as our logistic regression training framework. The scikit-learn model trains itself on the DataFrames, where the labels are a one-dimensional numpy array that takes on value 0 for in-sample points and 1 for out-of-sample.

Once the discriminator is trained on a sample of X_{IS} and X_{OOS} (either raw or normalized), the computing machine generates weights for the remaining points that belong to X_{OOS}. The computing machine does this by calculating

$${p}_{OOS} ( x ) / {p}_{IS} ( x ) = \frac{1}{{f}_{disc} ( x )} - 1.$$

Some embodiments also clip the discriminator outputs f_{disc}(x) to fall between 0.01 and 1 so as not to avoid infinite weights. Some embodiments do this via standard vectorized numpy operations. This is a novel use of a scikit-learn classifier object to calculate importance sampling weights.

Some embodiments use the discriminator. Using these sample weights, some embodiments calculate any weighted metric measurement (AUC-ROC, precision, recall, accuracy, F1-score, and beyond) and use this as our metric estimation. In practice, this can be done with scikit-learn's standard library of metrics using the sample_weight parameter to provide weights.

Quantitative Input Influence (QII), computes feature influence for a sample of data points in the training data set. The general method of computing QII is described as an illustrative example.

Quantitative Input Influence (QII) measures the degree of influence that each input feature exerts on the outputs of the system. There are several variants of QII. Unary QII computes the difference in outputs arising from two related input distributions—the real distribution and a hypothetical (or counterfactual) distribution that is constructed from the real distribution to account for correlations among inputs. Unary QII can be generalized to a form of joint influence of a set of inputs, called Set QII. A third method defines Marginal QII, which measures the difference in output based on comparing training data with and without the specific input whose marginal influence some embodiments want to measure. Depending on the application, some embodiments may choose the training sets the embodiments compare in different ways, leading to several different variants of Marginal QII.

Some embodiments include implementing the recalibration method. First, some embodiments generate the sample weights p_{OOS}(x)/p_{IS}(x) as above. Second, some embodiments calibrate the underlying model f using isotonic regression, fitting it to X_{IS}, Y_{IS} with sample weights from the first step. The isotonic regression module may be found within the scikit-learn framework. Third, using the calibrated classifier f_{cal}, some embodiments then generate predicted labels for OOS data by calculating f_{cal}(x) for x in X_{OOS}, again using scikit-learn to generate predicted labels from the underlying model object.

Fourth, for a given threshold t, some embodiments estimate the number of false positive as Σ_{x|f(x)<t}f_{cal}(X). Some embodiments can similarly estimate the number of true negatives Σ_{x|f(x)<t}1−f_{cal}(x), and by extension, the number of true positives and false negatives. Using this, some embodiments can generate the true/false positive/negative rates of the original classifier for a variety of thresholds. Some embodiments do this for all possible thresholds, which is equal to the number of points in X_{OOS}, and can do this efficiently via a cumulative sum. Note that many alternative characterizations of the goodness of the classification function, such as AUC-ROC, precision/recall, F1-score, etc. can be expressed in terms of these four functions. This is all accomplished via numpy operations so as to be vectorized.

Fifth, to calculate estimated accuracy, some embodiments first pick a threshold t. Some embodiments then calculate the mean of [[f(x)<t]](1−f_{cal}(x)) +[[f(x)≥t]](f_{cal}(x)) for all x∈X_{OOS}. Sixth, to estimate ROC-AUC some embodiments use trapezoidal numerical integration (e.g., available within the scipy Python library) to integrate the true positive rate with respect to the false positive rate. For precision and recall curves, the standard formulas in terms of true/false positive/negative rates may apply.

There are a few failure modes of this technique. If there is OOS data that is not within the support of the IS data distribution, this will lead to importance sampling weights of infinity, biasing the recalibration or reweighting methods to these points in an extreme way. The discriminator may be unable to distinguish between IS and OOS points even though data drift has occurred, which could be the case if the discriminator is not expressive enough. If the original classifier f is not expressive or high-performing enough to give correct estimates of p(y|x), which makes the model estimations error-prone. If the assumption that p(y|x) remains unchanged between the in-sample and out-of-sample distributions is incorrect, some embodiments cannot make accurate estimations because concept drift has occurred.

Metrics for the quality of estimated out of sample performance can be constructed by introspecting on the performances of each model in either the recalibration or reweight pipelines. The accuracy of the discriminator, for example, can indicate that a spurious variable can be used to separate in-sample and out-of-sample data (say an application date) and thereby bias our calculation of the ratio p_{OOS}(x)/p_{IS}(x)

In order to attach a confidence to each estimate, some embodiments ensure that the performance of f_{disc} and f are reasonably high and that no importance sampling weights are abnormally high (>200) or low (<0.005).

Some embodiments are able to estimate the accuracy of a classifier on new, unlabeled data. Some embodiments leverage a binary classifier model (referred to as the “discriminator”) in a novel way to generate importance sampling weights for two distributions. This precludes the need to use density estimation techniques (e.g., kernel density estimation (KDE)) to estimate the ratio p_{OOS}(x)/p_{IS}(x). Some embodiments build upon techniques in learning normalized influences in the QII space to ensure that the estimation of the ratio p_{OOS}(x)/p_{IS}(x) is robust in the context of a specific classification problem, even for extremely large datasets with many spurious features.

Some embodiments relate to a conditional probability augmented dataset. For each datapoint x, a computing machine holds the following values in a custom Python class derived from numpy array with: x: floats with each feature value for the input datapoint; y: integer with value 0 or 1 indicating the true label of the datapoint (if the label is not available, it is set to none); in sample: boolean value indicating whether the given data point belongs to the in-sample data (IS) or out-of-sample (OOS) data (used for discriminator methods); inf(x): numpy array of floats with the influence of each feature value for the input data point towards the output score of the model (used for discriminator method based on QII); and p_{OOS}(x)/p_{IS}(x): float indicating the ratio of the probabilities that the given data point x is in-sample (versus out-of-sample, calculated using the logistic regression discriminator model).

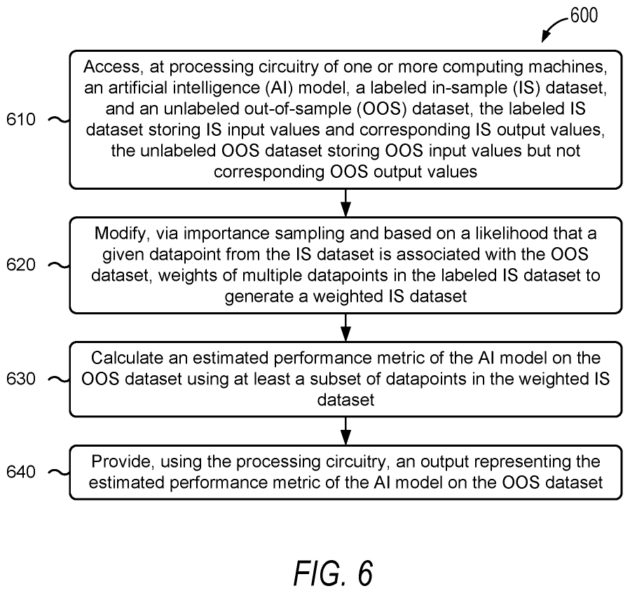

FIG. 6 is a flowchart of an example process 600 associated with estimating model metrics without labels. In some implementations, one or more process blocks of FIG. 6 may be performed by a computing machine (e.g., computing machine 500). In some implementations, one or more process blocks of FIG. 6 may be performed by another device or a group of devices separate from or including the computing machine. Additionally, or alternatively, one or more process blocks of FIG. 6 may be performed by one or more components of the computing machine 500, such as processor 502, main memory 504, static memory 506, network interface device 520, video display 510, alpha-numeric input device 512, UI navigation device 512, drive unit 516, signal generation device 518, and output controller 528.

As shown in FIG. 6, process 600 may include accessing, at processing circuitry of one or more computing machines, an artificial intelligence (AI) model, a labeled in-sample (IS) dataset, and an unlabeled out-of-sample (OOS) dataset, the labeled IS dataset storing IS input values and corresponding IS output values, the unlabeled OOS dataset storing OOS input values but not corresponding OOS output values (block 610). For example, the computing machine may access, at processing circuitry, an artificial intelligence (AI) model, a labeled in-sample (IS) dataset, and an unlabeled out-of-sample (OOS) dataset, the labeled IS dataset storing IS input values and corresponding IS output values, the unlabeled OOS dataset storing OOS input values but not corresponding OOS output values, as described above.

As further shown in FIG. 6, process 600 may include modifying, via importance sampling and based on a likelihood that a given datapoint from the IS dataset is associated with the OOS dataset, weights of multiple datapoints in the labeled IS dataset to generate a weighted IS dataset (block 620). For example, the computing machine may modify, via importance sampling and based on a likelihood that a given datapoint from the IS dataset is associated with the OOS dataset, weights of multiple datapoints in the labeled IS dataset to generate a weighted IS dataset, as described above.

As further shown in FIG. 6, process 600 may include calculating an estimated performance metric of the AI model on the OOS dataset using at least a subset of datapoints in the weighted IS dataset (block 630). For example, the computing machine may calculate an estimated performance metric of the AI model on the OOS dataset using at least a subset of datapoints in the weighted IS dataset, as described above.

As further shown in FIG. 6, process 600 may include providing, using the processing circuitry, an output representing the estimated performance metric of the AI model on the OOS dataset (block 640). For example, the computing machine may provide, using the processing circuitry, an output representing the estimated performance metric of the AI model on the OOS dataset, as described above.

Process 600 may include additional implementations, such as any single implementation or any combination of implementations described below and/or in connection with one or more other processes described elsewhere herein.

In a first implementation, the labeled IS dataset comprises model input values (x) and model output values (y), wherein the unlabeled OOS dataset comprises model input values (x) and lacks model output values, wherein the importance sampling comprises calculating, for a given model input value, a probability that the given model input value is associated with the IS dataset (pᵢₛ(x)) using density estimation, calculating, for the given model input value, a probability that the given model input value is associated with the OOS dataset (pₒₒₛ(x)) using density estimation, and calculating a probability that the given model input value corresponds to a given output value (y) for the OOS dataset (pₒₒₛ(x,y)) based on the probability that the given model input value is associated with the OOS dataset divided by the probability that the given model input value is associated with the IS dataset (pₒₒₛ(x)/pᵢₛ(x)), wherein the estimated performance metric of the AI model on the OOS dataset is calculated based on the probability that the given model input value corresponds to the given output value.

In a second implementation, the importance sampling comprises density estimation of the IS dataset and the OOS dataset.

In a third implementation, the importance sampling comprises training a discriminator engine to discriminate between datapoints in the IS dataset and datapoints in the OOS dataset by computing a probability that a given datapoint belongs in the IS dataset rather than the OOS dataset.

In a fourth implementation, the OOS dataset has at least a first threshold amount of data drift from the IS dataset and at most a second threshold amount of concept drift from the IS dataset.

In a fifth implementation, process 600 includes the discriminator engine computes a quotient between a probability that a given datapoint is in the OOS dataset and a probability that the given datapoint is in the IS dataset, the probability that the given datapoint is in the OOS dataset is computed using density estimation, and the probability that the given datapoint is in the IS dataset is computed using density estimation.

In a sixth implementation, the discriminator engine leverages a logistic regression model that distinguishes between datapoints in the IS dataset and datapoints in the OOS dataset.

In a seventh implementation, the discriminator engine leverages a generative adversarial network (GAN) that distinguishes between datapoints in the IS dataset and datapoints in the OOS dataset.

In an eighth implementation, the discriminator engine computes, for one or more features of the IS dataset and the OOS dataset, a quantitative input influence (QII) score for predicting whether a feature value for the one or more features are likely to be associated with the IS dataset or the OOS dataset.

In a ninth implementation, the performance metric comprises one or more of precision, recall, F1-score, receiver operating characteristic area under the curve (ROC-AUC), and classification accuracy.

In a tenth implementation, the performance metric comprises a quantity defined by a ground truth label and a predicted label probability.

In an eleventh implementation, process 600 includes the processing circuitry comprises a multithreaded processing unit (e.g., a multithreaded graphics processing unit and/or a multithreaded central processing unit), and the weights of multiple datapoints in the labeled IS dataset are modified in parallel using multiple threads of the multithreaded processing unit.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

Some embodiments are described as numbered examples (Example 1, 2, 3, etc.). These are provided as examples only and do not limit the technology disclosed herein.

Example 1 is a method comprising: accessing, at processing circuitry of one or more computing machines, an artificial intelligence (AI) model, a labeled in-sample (IS) dataset, and an unlabeled out-of-sample (OOS) dataset, the labeled IS dataset storing IS input values and corresponding IS output values, the unlabeled OOS dataset storing OOS input values but not corresponding OOS output values; modifying, via importance sampling and based on a likelihood that a given datapoint from the IS dataset is associated with the OOS dataset, weights of multiple datapoints in the labeled IS dataset to generate a weighted IS dataset; calculating an estimated performance metric of the AI model on the OOS dataset using at least a subset of datapoints in the weighted IS dataset; and providing, using the processing circuitry, an output representing the estimated performance metric of the AI model on the OOS dataset.

In Example 2, the subject matter of Example 1 includes, wherein the labeled IS dataset comprises model input values (x) and model output values (y), wherein the unlabeled OOS dataset comprises model input values (x) and lacks model output values, wherein the importance sampling comprises: calculating, for a given model input value, a probability that the given model input value is associated with the IS dataset (pᵢₛ(x)) using density estimation; calculating, for the given model input value, a probability that the given model input value is associated with the OOS dataset (pₒₒₛ(x)) using density estimation; and calculating a probability that the given model input value corresponds to a given output value (y) for the OOS dataset (pₒₒₛ(x,y)) based on the probability that the given model input value is associated with the OOS dataset divided by the probability that the given model input value is associated with the IS dataset (pₒₒₛ(x)/pᵢₛ(x)), wherein the estimated performance metric of the AI model on the OOS dataset is calculated based on the probability that the given model input value corresponds to the given output value.

In Example 3, the subject matter of Example 2 includes, wherein the importance sampling comprises density estimation of the IS dataset and the OOS dataset.

In Example 4, the subject matter of Examples 2-3 includes, wherein the importance sampling comprises training a discriminator engine to discriminate between datapoints in the IS dataset and datapoints in the OOS dataset by computing a probability that a given datapoint belongs in the IS dataset rather than the OOS dataset.

In Example 5, the subject matter of Examples 1-4 includes, wherein the OOS dataset has at least a first threshold amount of data drift from the IS dataset and at most a second threshold amount of concept drift from the IS dataset.

In Example 6, the subject matter of Example 5 includes, wherein: the discriminator engine computes a quotient between a probability that a given datapoint is in the OOS dataset and a probability that the given datapoint is in the IS dataset, the probability that the given datapoint is in the OOS dataset is computed using density estimation, and the probability that the given datapoint is in the IS dataset is computed using density estimation.

In Example 7, the subject matter of Examples 5-6 includes, wherein the discriminator engine leverages a logistic regression model that distinguishes between datapoints in the IS dataset and datapoints in the OOS dataset.

In Example 8, the subject matter of Examples 5-7 includes, wherein the discriminator engine leverages a generative adversarial network (GAN) that distinguishes between datapoints in the IS dataset and datapoints in the OOS dataset.

In Example 9, the subject matter of Examples 5-8 includes, wherein the discriminator engine computes, for one or more features of the IS dataset and the OOS dataset, a quantitative input influence (QII) score for predicting whether a feature value for the one or more features are likely to be associated with the IS dataset or the OOS dataset.

In Example 10, the subject matter of Examples 1-9 includes,—score, receiver operating characteristic area under the curve (ROC-AUC), and classification accuracy.

In Example 11, the subject matter of Examples 1-10 includes, wherein the performance metric comprises a quantity defined by a ground truth label and a predicted label probability.

In Example 12, the subject matter of Examples 1-11 includes, wherein: the processing circuitry comprises a multithreaded processing unit, and the weights of multiple datapoints in the labeled IS dataset are modified in parallel using multiple threads of the multithreaded processing unit.

Example 13 is at least one machine-readable medium including instructions that, when executed by processing circuitry, cause the processing circuitry to perform operations to implement of any of Examples 1-12.

Example 14 is an apparatus comprising means to implement of any of Examples 1-12.

Example 15 is a system to implement of any of Examples 1-12.

Example 16 is a method to implement of any of Examples 1-12.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method comprising:
accessing, at processing circuitry of one or more computing machines, an artificial intelligence (AI) model, a labeled in-sample (IS) dataset, and an unlabeled out-of-sample (OOS) dataset, the labeled IS dataset storing IS input values and corresponding IS output values, the unlabeled OOS dataset storing OOS input values but not corresponding OOS output values;
modifying, via importance sampling and based on a likelihood that a given datapoint from the IS dataset is associated with the OOS dataset, weights of multiple datapoints in the labeled IS dataset to generate a weighted IS dataset;
calculating an estimated performance metric of the AI model on the OOS dataset using at least a subset of datapoints in the weighted IS dataset; and
providing, using the processing circuitry, an output representing the estimated performance metric of the AI model on the OOS dataset.

2. The method of claim 1, wherein the labeled IS dataset comprises model input values (x) and model output values (y), wherein the unlabeled OOS dataset comprises model input values (x) and lacks model output values, wherein the importance sampling comprises:
calculating, for a given model input value, a probability that the given model input value is associated with the IS dataset (pᵢₛ(x)) using density estimation;
calculating, for the given model input value, a probability that the given model input value is associated with the OOS dataset (pₒₒₛ(x)) using density estimation; and
calculating a probability that the given model input value corresponds to a given output value (y) for the OOS dataset (pₒₒₛ(x,y)) based on the probability that the given model input value is associated with the OOS dataset divided by the probability that the given model input value is associated with the IS dataset (pₒₒₛ(x)/pᵢₛ(x)), wherein the estimated performance metric of the AI model on the OOS dataset is calculated based on the probability that the given model input value corresponds to the given output value.

3. The method of claim 2, wherein the importance sampling comprises density estimation of the IS dataset and the OOS dataset.

4. The method of claim 2, wherein the importance sampling comprises training a discriminator engine to discriminate between datapoints in the IS dataset and datapoints in the OOS dataset by computing a probability that a given datapoint belongs in the IS dataset rather than the OOS dataset.

5. The method of claim 4, wherein the OOS dataset has at least a first threshold amount of data drift from the IS dataset and at most a second threshold amount of concept drift from the IS dataset.

6. The method of claim 5, wherein:
the discriminator engine computes a quotient between a probability that a given datapoint is in the OOS dataset and a probability that the given datapoint is in the IS dataset,
the probability that the given datapoint is in the OOS dataset is computed using density estimation, and
the probability that the given datapoint is in the IS dataset is computed using density estimation.

7. The method of claim 5, wherein the discriminator engine leverages a logistic regression model that distinguishes between datapoints in the IS dataset and datapoints in the OOS dataset.

8. The method of claim 5, wherein the discriminator engine leverages a generative adversarial network (GAN) that distinguishes between datapoints in the IS dataset and datapoints in the OOS dataset.

9. The method of claim 5, wherein the discriminator engine computes, for one or more features of the IS dataset and the OOS dataset, a quantitative input influence (QII) score for predicting whether a feature value for the one or more features are likely to be associated with the IS dataset or the OOS dataset.

10. The method of claim 1, wherein the performance metric comprises one or more of: precision, recall, F1-score, receiver operating characteristic area under the curve (ROC-AUC), and classification accuracy.

11. The method of claim 1, wherein the performance metric comprises a quantity defined by a ground truth label and a predicted label probability.

12. The method of claim 1, wherein:
the processing circuitry comprises a multithreaded processing unit, and
the weights of multiple datapoints in the labeled IS dataset are modified in parallel using multiple threads of the multithreaded processing unit.

13. A system comprising:
a memory comprising instructions; and
one or more computer processors, wherein the instructions, when executed by the one or more computer processors, cause the system to perform operations comprising:
accessing an artificial intelligence (AI) model, a labeled in-sample (IS) dataset, and an unlabeled out-of-sample (OOS) dataset, the labeled IS dataset storing IS input values and corresponding IS output values, the unlabeled OOS dataset storing OOS input values but not corresponding OOS output values;
modifying, via importance sampling and based on a likelihood that a given datapoint from the IS dataset is associated with the OOS dataset, weights of multiple datapoints in the labeled IS dataset to generate a weighted IS dataset;
calculating an estimated performance metric of the AI model on the OOS dataset using at least a subset of datapoints in the weighted IS dataset; and
providing an output representing the estimated performance metric of the AI model on the OOS dataset.

14. The system as recited in claim 13, wherein the labeled IS dataset comprises model input values (x) and model output values (y), wherein the unlabeled OOS dataset comprises model input values (x) and lacks model output values, wherein the importance sampling comprises:
calculating, for a given model input value, a probability that the given model input value is associated with the IS dataset (pᵢₛ(x)) using density estimation;
calculating, for the given model input value, a probability that the given model input value is associated with the OOS dataset (pₒₒₛ(x)) using density estimation; and
calculating a probability that the given model input value corresponds to a given output value (y) for the OOS dataset (pₒₒₛ(x,y)) based on the probability that the given model input value is associated with the OOS dataset divided by the probability that the given model input value is associated with the IS dataset (pₒₒₛ(x)/pᵢₛ(x)), wherein the estimated performance metric of the AI model on the OOS dataset is calculated based on the probability that the given model input value corresponds to the given output value.

15. The system as recited in claim 14, wherein the importance sampling comprises density estimation of the IS dataset and the OOS dataset.

16. The system as recited in claim 14, wherein the importance sampling comprises training a discriminator engine to discriminate between datapoints in the IS dataset and datapoints in the OOS dataset by computing a probability that a given datapoint belongs in the IS dataset rather than the OOS dataset.

17. The system as recited in claim 13, wherein the OOS dataset has at least a first threshold amount of data drift from the IS dataset and at most a second threshold amount of concept drift from the IS dataset.

18. A tangible machine-readable storage medium including instructions that, when executed by a machine, cause the machine to perform operations comprising:
accessing an artificial intelligence (AI) model, a labeled in-sample (IS) dataset, and an unlabeled out-of-sample (OOS) dataset, the labeled IS dataset storing IS input values and corresponding IS output values, the unlabeled OOS dataset storing OOS input values but not corresponding OOS output values;
modifying, via importance sampling and based on a likelihood that a given datapoint from the IS dataset is associated with the OOS dataset, weights of multiple datapoints in the labeled IS dataset to generate a weighted IS dataset;
calculating an estimated performance metric of the AI model on the OOS dataset using at least a subset of datapoints in the weighted IS dataset; and
providing an output representing the estimated performance metric of the AI model on the OOS dataset.

19. The tangible machine-readable storage medium as recited in claim 18, wherein the labeled IS dataset comprises model input values (x) and model output values (y), wherein the unlabeled OOS dataset comprises model input values (x) and lacks model output values, wherein the importance sampling comprises:
calculating, for a given model input value, a probability that the given model input value is associated with the IS dataset (pᵢₛ(x)) using density estimation;
calculating, for the given model input value, a probability that the given model input value is associated with the OOS dataset (pₒₒₛ(x)) using density estimation; and
calculating a probability that the given model input value corresponds to a given output value (y) for the OOS dataset (pₒₒₛ(x,y)) based on the probability that the given model input value is associated with the OOS dataset divided by the probability that the given model input value is associated with the IS dataset (pₒₒₛ(x)/pᵢₛ(x)), wherein the estimated performance metric of the AI model on the OOS dataset is calculated based on the probability that the given model input value corresponds to the given output value.

20. The tangible machine-readable storage medium as recited in claim 19, wherein the importance sampling comprises density estimation of the IS dataset and the OOS dataset.
